(19) United States
(12) Patent Application Publication
(10) Pub. No.: US 2007/0209598 A1
(43) Pub. Date: Sep. 13, 2007

(54) ANIMAL WATER DISPENSING DEVICE

(76) Inventor: Dave Austin, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/684,411

(22) Filed: Mar. 9, 2007

Related U.S. Application Data
(60) Provisional application No. 60/780,724, filed on Mar. 9, 2006.

(51) Int. Cl. A01K 39/00

(52) U.S. Cl. 119/51.01

(57) ABSTRACT

An animal water dispensing device which includes a receptacle for retaining water and a tank for storing water which engages with a top portion of the receptacle. The top portion of the receptacle includes a half bowl shaped area where the half bowl shaped area extends above and beyond a bottom portion of the receptacle. The device may also include a planar support plate extending from a back of the bottom portion of the receptacle.

### CROSS-REFERENCE TO RELATED APPLICATIONS

This application claims priority to provisional patent application having Ser. No. 60/780,724, filed Mar. 9, 2006, which is herein incorporated in its entirety.

### FIELD OF INVENTION

The present invention is generally directed to an animal water dispensing device and, more particularly, to an animal water dispensing device which includes a water retaining receptacle having a bottom portion and a top portion where the top portion includes a half bowl shaped area extending beyond the bottom portion and a tank member removably engaged with the top portion of the receptacle.

### BACKGROUND OF THE INVENTION

A large number of animal water dispensing devices exist in the prior art which automatically replenish the water supply contained in them by using gravity or some other automated replenishment means that responds to a float or water leveler contained in the device. For example, U.S. Pat. No. 5,809,934 discloses an automatic water dispensing device having a main container/tank, a trough extending from the lower front end of the container that receives fluid from the tank, a fluid control valve fluidly communicating the trough and container, and a fluid monitoring gauge. In addition, U.S. Pat. No. 5,845,600 discloses an outer cylindrical housing with a top lid and an inner cylindrical water container concentric with and inverted within the outer cylindrical housing for storing and automatically dispensing water into a trough to maintain a predetermined water level in the trough. A magnetically responsive switch and magnetic float are used to maintain the water level in the trough.

However, although a great number of automated pet water dispensing devices and apparatus are present in the prior art, none include a water retaining receptacle that has at least a portion of the receptacle elevated above the ground to facilitate easy access and reduce spillage while at the same time being easily engaged with a tank for storing water such that the apparatus is stable and not prone to tipping. Accordingly, there is a need for an animal water dispensing device which 1) has a water retaining receptacle and water storage tank that are easily engaged, 2) has a streamlined configuration that provides elevated access to drinking and reduced spillage without tipping over, and 3) has the ability to automatically replenish the water retained in the receptacle.

### SUMMARY OF THE INVENTION

The invention is generally directed to an animal water dispensing device which includes a receptacle having top and bottom portions for retaining water and a tank removably engaged with the top portion of the receptacle so that an interior of the tank is exposed to an interior of the receptacle. The top portion of the receptacle includes a half bowl shaped area where the half bowl shaped area extends above and beyond the bottom portion of the receptacle.

The receptacle may also include a front and a back where a bottom of the receptacle is tapered in decreasing width from the front to the back. The half bowl shape comprises the top portion of the front of the receptacle. The receptacle also includes a first opening for receiving the tank and a second larger opening located over the half bowl shaped area of the receptacle for providing an animal with access to water retained within the receptacle. The second larger opening is preferably circular in shape to provide adequate access to the water.

The tank includes a hollow extension member extending from a bottom surface of the tank for engagement with the first opening of the receptacle. The hollow extension member may include a cap having an opening therein which is smaller in circumference than the hollow extension member. This configuration of the hollow extension member reduces the flow rate of water from the tank into the receptacle. The tank may also include a transparent window for monitoring the water level stored in the tank.

Another exemplary embodiment of the animal water dispensing device of the present invention includes a support member connected to the bottom portion of the receptacle such that it extends from the back of the receptacle. The support member may be generally rectangular in shape and may comprise a thin planar support plate.

### BRIEF DESCRIPTION OF THE DRAWINGS

The present invention is hereafter described in conjunction with the following drawing figures, wherein like numerals denote like elements, and:

FIG. 1 is a perspective view of a first exemplary embodiment of the animal water dispensing device of the present invention;

FIG. 2 is an exploded perspective view of the receptacle and tank of the animal water dispensing device of the present invention;

FIG. 3 is a bottom perspective view of the receptacle portion of the animal water dispensing device of the present invention;

FIG. 4 is a bottom perspective view of the tank portion of the animal water dispensing device of the present invention;

FIG. 5 is a side elevational view of the tank portion of the animal water dispensing device of the present invention;

FIG. 6 is a perspective view of a second exemplary embodiment of the animal water dispensing device of the present invention;

FIG. 7 is a top perspective view of the receptacle portion of the second exemplary embodiment of the animal water dispensing device of the present invention;

FIG. 8 is bottom perspective view of the receptacle portion of the second exemplary embodiment of the animal water dispensing device of the present invention; and

FIG. 9 is a top perspective view of the tank portion of the second exemplary embodiment of the animal water dispensing device of the present invention.

### DETAILED DESCRIPTION

The following description is of exemplary embodiments of the invention only, it is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention set forth in the appended claims. For example, in the context of the present invention, the hollow extension member of the tank may comprise a number of configurations. In addition, the corresponding opening in the receptacle for engaging the hollow extension member of the tank may also comprise a similar number of varying configurations so long as the hollow extension member of the tank is capable of engaging the first opening in the receptacle for receiving the tank.

In general, the present invention provides an animal water dispensing device which includes a receptacle for retaining water having a top portion and bottom portion where the top portion includes a half bowl shaped area located at a top front of the receptacle and a tank member removably engaged with the top portion of the receptacle. In addition, a support member may be attached to the bottom portion of the receptacle.

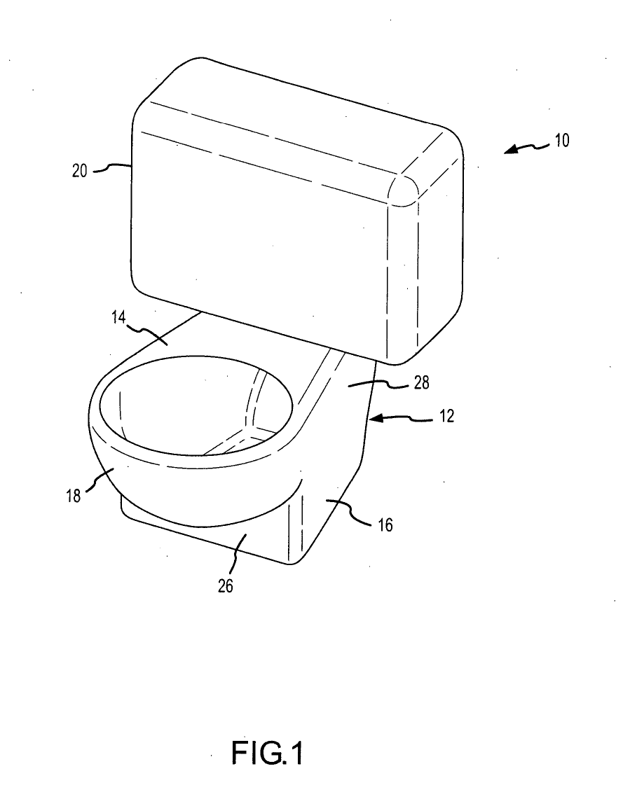

FIG. 1 is a perspective view of a first exemplary embodiment of the animal water dispensing device 10 of the present invention. Animal water dispensing device 10 includes a receptacle 12 for containing water having a top portion 14 and bottom portion 16. Top portion 14 of receptacle 12 includes a half bowl shaped area 18 which extends from a top front portion of receptacle 12. Half bowl shaped area 18 of receptacle 12 extends above and beyond bottom portion 16 of receptacle 12.

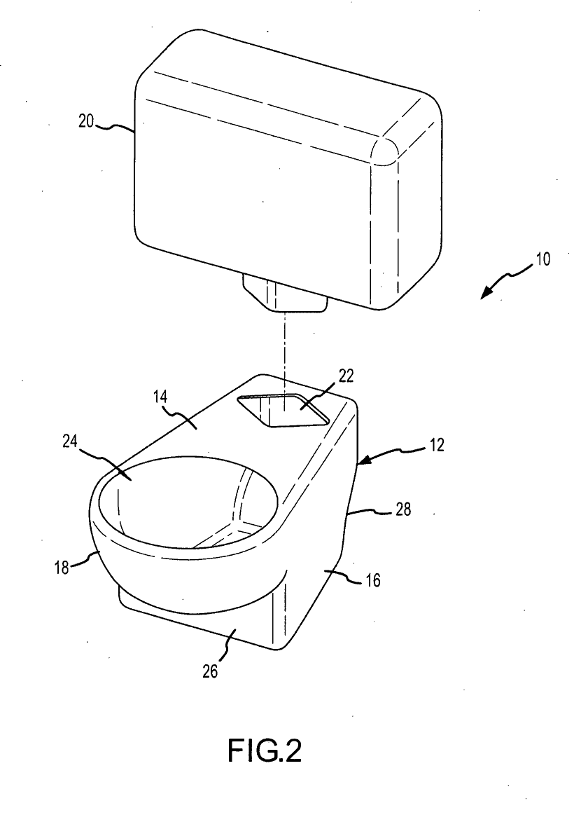

Animal water dispensing device 10 also includes a tank member 20 which is removably engaged with top portion 14 of receptacle 12. An exploded perspective view of the receptacle 12 and tank member 20 of animal water dispensing device 10 is shown in FIG. 2. As more clearly seen in FIG. 2, top portion 14 of receptacle 12 includes a first opening 22 for receiving tank member 20 and a second larger opening 24 located over half bowl shaped area 18 for providing an animal with access to water contained in receptacle 12. The second larger opening 24 is preferably circular in shape to enable easy access to the interior of receptacle 12.

Receptacle 12 may be comprised of any sturdy, solid, durable material such as, for example, metal, polymer, fiberglass, or any other similar material which can serve its intended purpose. Likewise, tank member 20 may also be comprised of any sturdy, solid, durable material including those previously mentioned with respect to receptacle 12. However, tank member 20 is preferably comprised of a material that is lightweight enough to transport when tank member 20 is filled with water. In addition, it will be understood by those in the art that tank member 20 is preferably light enough to enable a user to invert the tank member 20 when it is filled with water to engage receptacle 12. Although receptacle 12 and tank member 20 may be comprised of different materials, they may also be comprised of the same material.

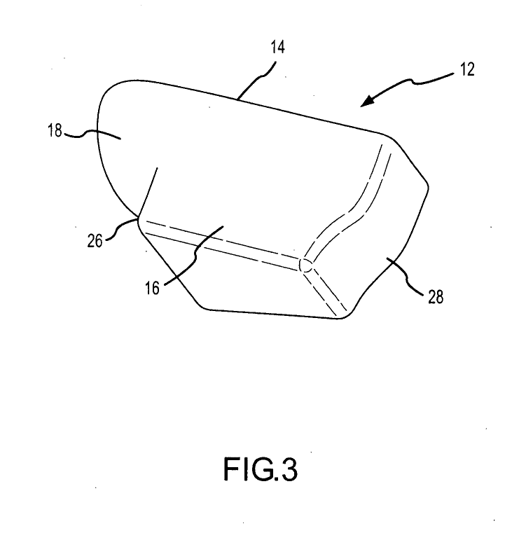

FIG. 3 is a bottom perspective view of receptacle 12 of animal water dispensing device 10. As shown in FIG. 3, bottom portion 16 of receptacle 12 is tapered such that it decreases in width from a front portion 26 of receptacle 12 toward a back portion 28 of receptacle 12. The half bowl shaped area 18 of receptacle 12 is positioned above bottom portion 16 of receptacle 12 and extends beyond front portion 26 of the bottom portion 16 of receptacle 12.

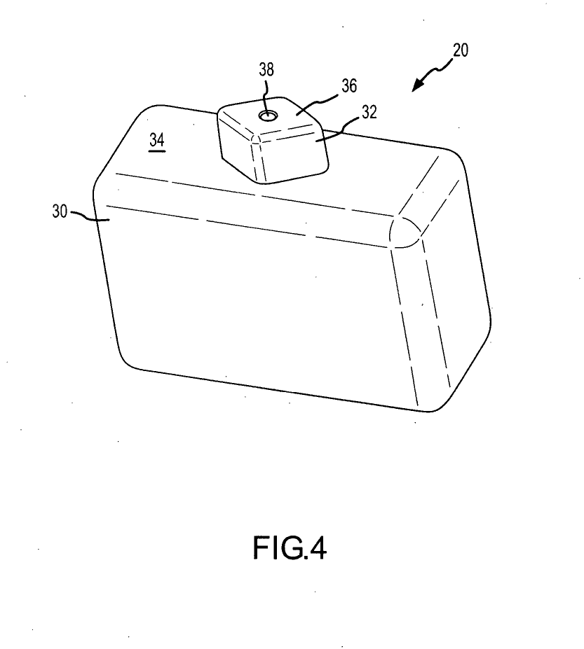

Turning now to FIG. 4, the bottom perspective view of tank member 20 of animal water dispensing device 10 is shown. Tank member 20 generally comprises a large rectangular container member 30 and a hollow extension member 32 extending from a bottom surface 34 of rectangular container member 30 such that an interior of hollow extension member 32 is contiguous with an interior of rectangular container member 30. Hollow extension member 32 may also include a cap member 36 having an opening 38 therein which functions to reduce the flow of water from tank member 20 into receptacle 12 when hollow extension member 32 engages with first opening 22 of receptacle 12.

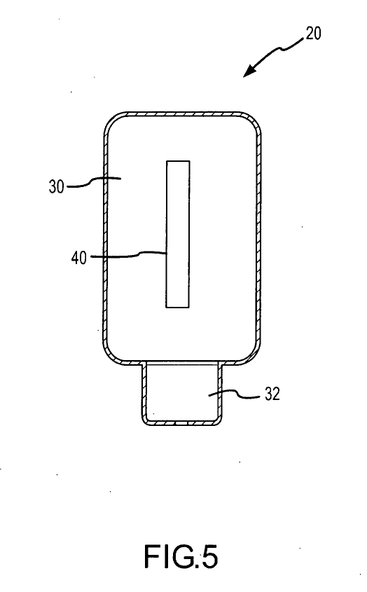

FIG. 5 is a side elevational view of tank member 20 of animal water dispensing device 10. As shown in FIG. 5, rectangular container member 30 of tank member 20 may include a transparent window 40 to enable a user to view the water level contained in tank member 20. Alternatively, transparent window 40 may also be positioned on a front side or a back side of rectangular container member 30 of tank member 20.

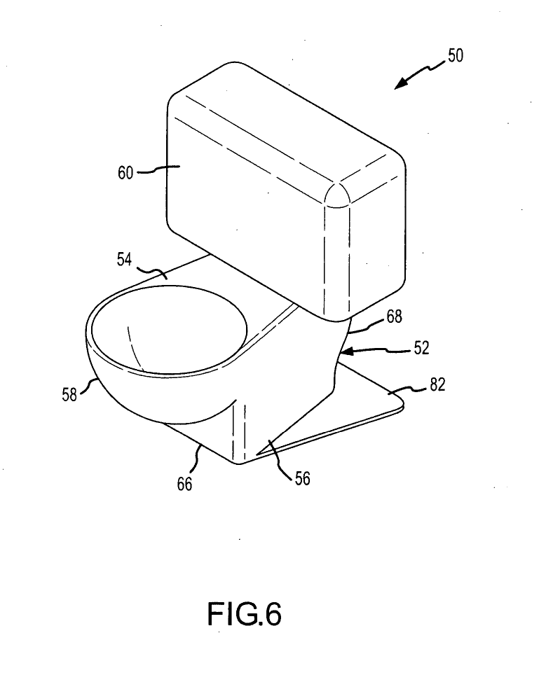

FIG. 6 illustrates a perspective view of a second exemplary embodiment of animal water dispensing device 50 of the present invention. Animal water dispensing device 50 includes a receptacle 52 for containing water having a top portion 54 and bottom portion 56. Top portion 54 of receptacle 52 includes a half bowl shaped area 58 which extends from a top front portion of receptacle 52. Half bowl shaped area 58 of receptacle 52 extends above and beyond bottom portion 56 of receptacle 52.

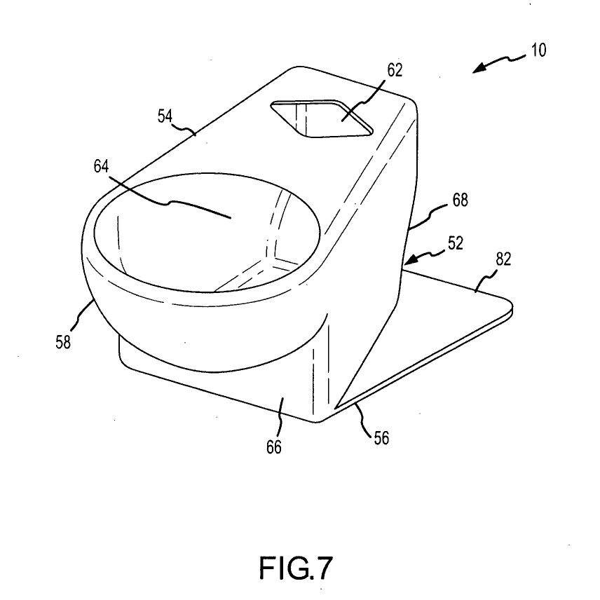

Animal water dispensing device 50 also includes a tank member 60 which is removably engaged with top portion 54 of receptacle 52. An top perspective view of the receptacle 52 of animal water dispensing device 50 is shown in FIG. 7. As more clearly seen in FIG. 7, top portion 54 of receptacle 52 includes a first opening 62 for receiving tank member 60 and a second larger opening 64 located over half bowl shaped area 58 for providing an animal with access to water contained in receptacle 52. The second larger opening 64 is preferably circular in shape to enable easy access to the interior of receptacle 52.

However, unlike the first exemplary embodiment of the animal water dispensing device 10 shown in FIG. 1, the second exemplary embodiment of the device 50 shown in FIGS. 6 and 7 includes a support member 82 which extends from the sides and back of the bottom portion 56 of receptacle 52. Support member 82 may be generally rectangular in shape in the event that receptacle 52 is positioned over and on top of support member 82. The height of support member 82 is less than a height of receptacle 52 and a height of tank member 60. Moreover, support member 82 may comprise a thin planar support plate and shown in FIGS. 6 and 7.

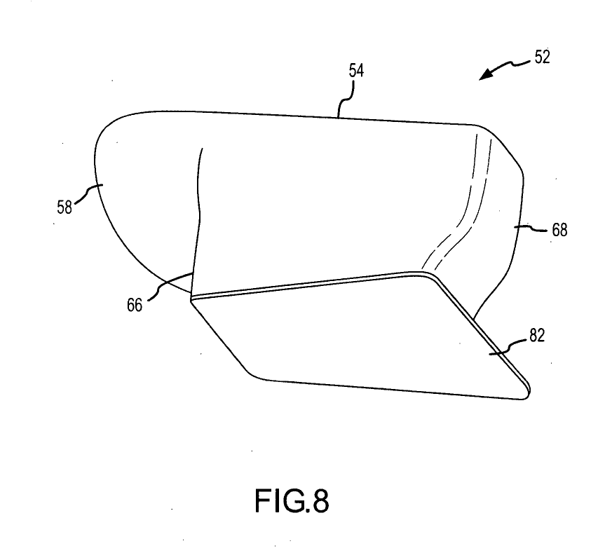

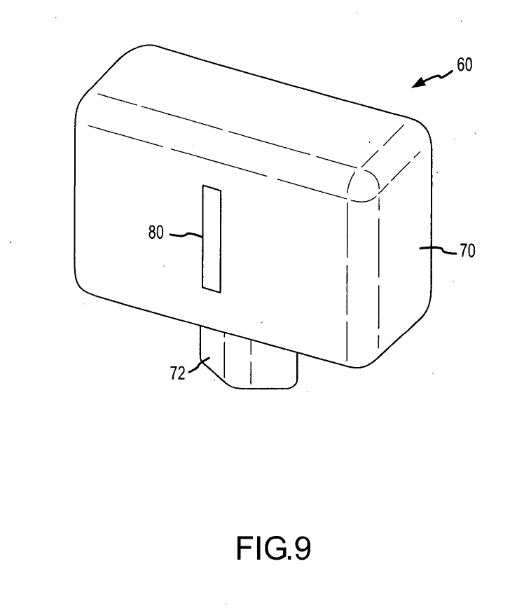

FIG. 8 is a bottom perspective view of receptacle 52 of animal water dispensing device 50 which shows receptacle 52 positioned over and on top of support member 82 wherein support member 82 comprises a thin planar support plate which extends beyond the sides of bottom portion 56 of receptacle 52 and back portion 68 of bottom portion 56 of receptacle 52. A top perspective view of tank member 60 of animal water dispensing device 50 is shown in FIG. 9. Tank member 60 shown in FIG. 9 is identical to tank member 20 shown in FIG. 4 with the exception of a transparent window 80 located on a front of rectangular container member 70 of tank member 60.

Many modifications and other embodiments of the invention set forth herein will come to mind to one skilled in the art to which this invention pertains having the benefit of the teachings presented in the foregoing descriptions and the associated drawings. Therefore, it needs to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An animal water dispensing device comprising:
a receptacle for retaining water having a top portion, a bottom portion, a front portion, and a rear portion wherein a top front portion comprises a half bowl shape which extends beyond a front surface area of the bottom portion; and
a tank removably engaged with the top portion of the receptacle such that an interior of the tank is exposed to an interior of the receptacle.

2. The device of claim 1 wherein the top portion of the receptacle includes a first opening for receiving the tank and a second larger opening for providing an animal with access to an interior of the receptacle.

3. The device of claim 2 wherein the second larger opening is generally circular in shape.

4. The device of claim 1 wherein the tank includes a hollow extension member for engaging the receptacle.

5. The device of claim 4 wherein the hollow extension member includes a cap member having an opening therein which is smaller in circumference than the hollow extension member.

6. The device of claim 1 wherein the tank includes a transparent window.

7. The device of claim 1 further comprising a support member connected to the bottom portion of the receptacle.

8. The device of claim 7 wherein the support member is generally rectangular in shape.

9. The device of claim 7 wherein the support member extends from a rear of the bottom portion of the receptacle.

10. The device of claim 7 wherein a height of the support member is less than a height of the receptacle and a height of the tank.

11. The device of claim 7 wherein the support member comprises a thin planar support plate.

12. The device of claim 1 wherein the receptacle resembles a toilet bowl and the tank resembles a toilet tank.

13. An animal water dispensing device comprising:
a water retaining receptacle having a bottom portion and a top portion which includes a half bowl shaped area wherein the half bowl shaped area of the top portion extends above and beyond the bottom portion; and
a tank member removably engaged with the top portion of the receptacle.

14. The device of claim 13 wherein the receptacle includes a front and a back and the receptacle is tapered in decreasing width from the front to the back.

15. The device of claim 14 wherein the half bowl shaped area comprises the top portion of the front of the receptacle.

16. The device of claim 13 wherein the top portion of the receptacle includes a first opening for receiving the tank and a second larger opening over the half bowl shaped area for providing an animal with access to an interior of the receptacle.

17. The device of claim 16 wherein the second larger opening is generally circular in shape.

18. The device of claim 13 wherein the tank includes a hollow extension member for engaging a receptacle.

19. The device of claim 13 wherein the tank includes a transparent window.

20. The device of claim 13 further comprising a support member connected to the bottom portion of the receptacle.

21. The device of claim.20 wherein the support member is generally rectangular in shape.

22. The device of claim 20 wherein the support structure extends from a rear of the bottom portion of the receptacle.

23. The device of claim 20 wherein a height of the support structure is less than the height of the receptacle and a height of the tank.
